(19) United States
(12) Patent Application Publication
(10) Pub. No.: US 2024/0311190 A1
(43) Pub. Date: Sep. 19, 2024

(54) HARDWARE-ASSISTED MEMORY DATA PLACEMENT

(71) Applicant: ADVANCE MICRO DEVICES, INC., Santa Clara, CA (US)

(72) Inventor: Matthew R. Poremba, Bellevue, WA (US)

(21) Appl. No.: 18/121,403

(22) Filed: Mar. 14, 2023

(51) Int. Cl. G06F 9/50; G06F 9/30; G06F 12/06

(52) U.S. Cl. CPC G06F 9/5016; G06F 9/3004; G06F 12/063

(57) ABSTRACT

A processor including a processing in memory (PIM) circuitry and one or more processor cores is coupled to a memory having a PIM unit. In response to the PIM circuitry receiving an instruction from a processor core to store data at a location in the memory, the PIM circuitry is configured to determine a memory address within location of the memory based on memory mappings, physical addresses, and the architecture of the memory. After determining the memory address within the location of the memory, the PIM circuitry is configured to then issue one or more instructions to store data in the determined memory address to the the PIM unit of the memory.

### BACKGROUND

Processing systems typically include a host device (e.g., a processor) configured to perform operations, such as data computations, on behalf of an executing application. To help expedite the performance of the operations, in some systems the host device is connected to a memory that includes processing in memory (PIM) units, wherein each PIM unit is configured to perform one or more of the operations and store data resulting from the operations in the memory. Additionally, to help expedite the performance of the operations, one or more PIM units are configured to store the resulting data in specific locations (e.g., layers, channels, memory banks) within the memory. To this end, software running on the processing system uses memory mappings, physical addresses, and the architecture of the memory to determine memory mappings for the storage of the data within the memory. However, exposing the memory mappings, physical addresses, and the architecture of the memory increases the risk of malicious software accessing the memory mappings, physical addresses, and the architecture of the memory, causing such information to be less secure.

### BRIEF DESCRIPTION OF THE DRAWINGS

The present disclosure may be better understood, and its numerous features and advantages are made apparent to those skilled in the art by referencing the accompanying drawings. The use of the same reference symbols in different drawings indicates similar or identical items.

FIG. 1 is a block diagram of a processing system implementing hardware-assisted memory data placement, in accordance with some embodiments.

FIG. 2 is a block diagram of a processing system including a host device implementing hardware-assisted memory data placement, in accordance with some embodiments.

FIG. 3 is a block diagram of a memory layer connected to a host device implementing hardware-assisted memory data placement, in accordance with some embodiments.

FIG. 4 is a signal flow diagram of an example process for hardware-assisted memory data placement, in accordance with some embodiments.

FIG. 5 is a flow diagram illustrating a method for hardware-assisted memory data placement, in accordance with some embodiments.

### DETAILED DESCRIPTION

Some processing systems include host devices (e.g., accelerating processing units, central processing unit) connected to one or more memories each including one or more processing in memory (PIM) units configured to perform operations, store data in the memory, read data from the memory or any combination thereof. In response to receiving one or more instructions from, for example, program code, the host device sends to a PIM unit one or more instructions indicating one or more operations to be performed, data to be read from the memory, data to be stored in the memory, one or more memory addresses in the memory in which to store the data, or any combination thereof. To help ensure that data is saved at a desired location (e.g., layer, channel, pseudo channel, memory bank, memory subbank) within the memory, the program code is configured to layout data within the program code in such a way that the data will be written to the desired location within the memory when instructions issued from the program code are executed by the host device, one or more PIM units of the memory, or both. That is to say, the program code includes data placed within a data structure (e.g., an array) such that the data in the data structure will be written to the desired location within the memory when instructions issued from the program code are executed by the host device, one or more PIM units of the memory, or both. To determine such data layouts, the program code is configured to use memory mappings of the memory, the memory architecture of the memory (e.g., the number of layers, channels, pseudo channels, memory banks, memory subbanks in the memory), or both to determine where data should be placed in a data structure (e.g., array), where unused elements should be placed in the data structure, or both such that the data in the data structure will be written to the desired location within the memory when instructions issued from the program code are executed. However, including such unused elements in the data structure to help ensure the data will be written to the desired location within the memory increases the size of the data structures used by the program code. As such, the processing efficiency of the processing system is decreased due to the increased size of the data structures. Additionally, exposing the memory mappings and memory architecture of a memory to the program code or other software to determine the data layouts allows for potential malicious program code or software to access the memory mappings and memory architecture of the memory, decreasing security in the processing system.

To this end, systems and techniques disclosed herein are directed to hardware-assisted memory data placement. For example, a host device (e.g., accelerated processing unit, central processing unit) includes or is otherwise connected to a hardware-based PIM circuitry. The PIM circuitry is configured to receive one or more instructions from, for example, the program code or a processor core of the host device, indicating one or more operations to be performed by a PIM unit, data to be stored in a memory, and a location (e.g., channel, pseudo channel, memory bank, memory subbank) within the memory in which to store the data. After receiving the instructions, the PIM circuitry determines one or more memory addresses within the memory based on the data to be stored in the memory and the location within the memory indicated by the received instructions. For example, using a memory mapping associated with the memory and the memory architecture, the PIM circuitry determines respective memory addresses within the indicated location (e.g., a channel) in the memory. The PIM circuitry then sends instructions indicating the operations to be performed, the data to be stored, and the memory addresses within the location of the memory in which to store the data to one or more PIM units of the memory. In this way, the hardware-based circuitry of the PIM circuitry has access to the memory mapping and a memory architecture of a memory rather than the program code or other software, decreasing the likelihood that malevolent software has access to the memory mapping and memory architecture and improving the security of the system. Additionally, because the PIM circuitry determines the memory addresses from the received instructions, unused elements are less likely to be needed in the data structures within the program code, increasing the processing efficiency of the processing system.

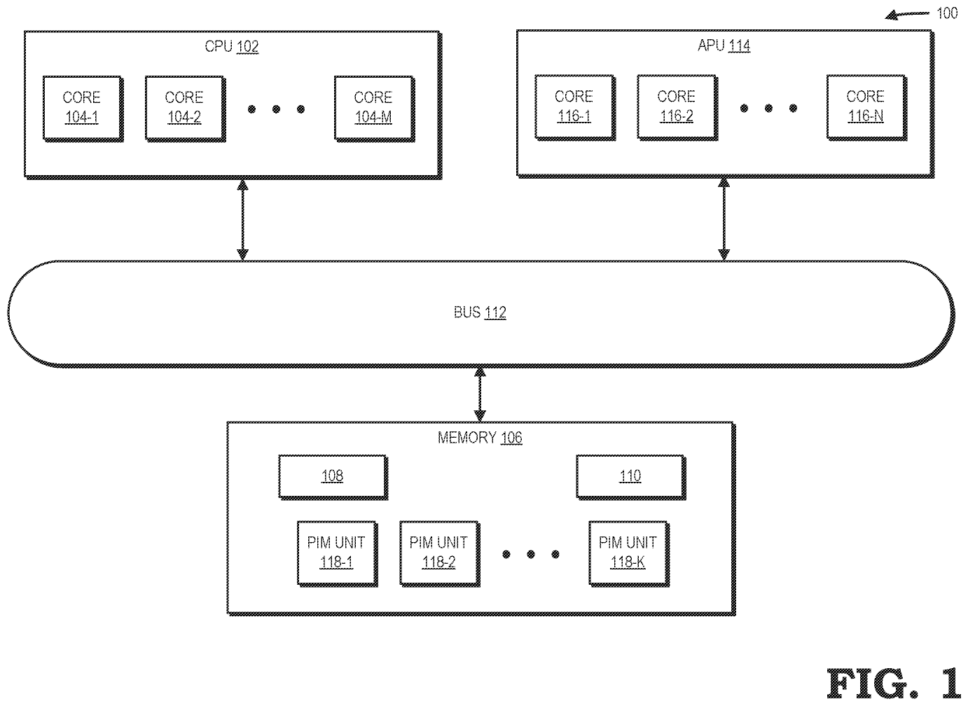

FIG. 1 is a block diagram of a processing system 100 implementing hardware-assisted memory data placement, according to some embodiments. The processing system 100 includes or has access to one or more memories 106 or other storage components each implemented using a non-transitory computer-readable medium, for example, a dynamic random-access memory (DRAM), static random access memory (SRAM), nonvolatile RAM, or any combination thereof, to name a few. In embodiments, one or more memories 106 include a three-dimensional (3D) stacked synchronous dynamic random-access memory (SDRAM) having one or more memory layers that each have one or more memory banks, memory subbanks, or both. Memory 106 includes an interface that includes hardware and software configured to communicatively couple memory 106 to one or more portions of processing system 100, for example, a High Bandwidth Memory (HBM) interface, a second-generation High Bandwidth Memory (HBM2) interface, a third-generation High Bandwidth Memory (HBM3) interface, or the like. According to embodiments, memory 106 is external to the processing units implemented in the processing system 100 while in other embodiments memory 106 is internal to the processing units implemented in the processing system 100. The processing system 100 also includes a bus 112 to support communication between entities implemented in the processing system 100, for example, central processing unit (CPU) 102 and accelerated processing unit (APU) 114. Some embodiments of the processing system 100 include other buses, bridges, switches, routers, and the like, which are not shown in FIG. 1 in the interest of clarity.

The techniques described herein are, in different embodiments, employed at any of a variety of parallel processors (e.g., vector processors, CPUs, GPUs, general-purpose GPUs (GPGPUs), non-scalar processors, highly-parallel processors, artificial intelligence (AI) processors, inference engines, machine learning processors, other multithreaded processing units, and the like), scalar processors, serial processors, or any combination thereof. FIG. 1 illustrates an example of a parallel processor and in particular APU 114, in accordance with some embodiments. The APU 114 renders images according to program code 110 (e.g., shader programs) for presentation on a display 120. For example, the APU 114 renders objects (e.g., groups of primitives) according to one or more shader programs to produce values of pixels that are provided to the display 120, which uses the pixel values to display an image that represents the rendered objects. To render the objects, the APU 114 implements a plurality of processor cores 116-1 to 116-N that execute instructions concurrently or in parallel from, for example, program code 110. For example, the APU 114 executes instructions from a shader program, graphics pipeline, or both using a plurality of processor cores 116 to render one or more objects. According to implementations, one or more processor cores 116 each operate as a compute unit including one or more single instruction, multiple data (SIMD) units that perform the same operation on different data sets. Though in the example implementation illustrated in FIG. 1, three processor cores (116-1, 116-2, 116-N) are presented representing an N number of cores, the number of processor cores 116 implemented in the APU 114 is a matter of design choice. As such, in other implementations, the APU 114 can include any number of processor cores 116. Some implementations of the APU 114 are used for general-purpose computing. The APU 114 executes instructions such as program code 110 (e.g., shader code) stored in a memory 106, and the APU 114 stores information in a memory 106 such as the results of the executed instruction.

The processing system 100 also includes a central processing unit (CPU) 102 that is connected to the bus 112 and therefore communicates with the APU 114 and the memory 106 via the bus 112. The CPU 102 implements a plurality of processor cores 104-1 to 104-N that execute instructions concurrently or in parallel. In embodiments, one or more of the processor cores 104 each operate as one or more compute units (e.g., SIMD units) that perform the same operation on different data sets. Though in the example embodiment illustrated in FIG. 1, three cores (104-1, 104-2, 104-M) are presented representing an M number of cores, the number of processor cores 104 implemented in the CPU 102 is a matter of design choice. As such, in other embodiments, the CPU 102 can include any number of cores 104. In some embodiments, the CPU 102 and APU 114 have an equal number of processor cores 104, 116 while in other embodiments, the CPU 102 and APU 114 have a different number of processor cores 104, 116. The processor cores 104 execute instructions such as program code 110 stored in a memory 106 and the CPU 102 stores information in a memory 106 such as the results of the executed instructions. The CPU 102 is also able to initiate graphics processing by issuing draw calls to the APU 114. In embodiments, the CPU 102 implements multiple processor cores (not shown in FIG. 1 in the interest of clarity) that execute instructions concurrently or in parallel.

According to embodiments, one or more memories 106 include or are otherwise connected to one or more processing in memory (PIM) units 118 that execute instructions concurrently or in parallel. For example, a memory 106 includes a stacked memory (e.g., SDRAM) including a logic layer that has one or more PIM units 118. In embodiments, one or more of the PIM units 118 each operate as one or more compute units (e.g., SIMD units) that perform the same operation on different data sets. Though in the example embodiment illustrated in FIG. 1, a memory 106 having three PIM units (118-1, 118-2, 118-K) representing a K number of PIM units 118 is presented, the number of PIM units 118 implemented in a memory 106 is a matter of design choice. As such, in other embodiments, a memory 106 can include any number of PIM units 118. The PIM units 118 of a memory 106, for example, execute instructions received from program code 110, instructions received from APU 114, instructions received from CPU 102, or any combination thereof and store information in the memory 106 such as the results of the executed instructions.

In embodiments, a PIM unit 118 is configured to store data in a respective memory 106 based on one or more instructions received from program code 110, instructions received from APU 114, instructions received from CPU 102, or any combination thereof. As an example, based on one or more instructions from program code 110 indicating, for example, one or more results to be determined by a PIM unit 118, data to be copied by a PIM unit 118, data to be written by a PIM unit 118 to a memory 106, data to be read from a memory 106 by a PIM unit 118, or any combination thereof, the PIM unit 118 is configured to store data in a respective memory 106 (e.g., the memory 106 including or otherwise connected to the PIM unit 118). According to embodiments, a PIM unit 118 stores data in a memory 106 in one or more locations (e.g., channel, memory bank, memory subbank) within the memory 106 based on one or more specified memory locations indicated in the instructions received from program code 110, APU 114, CPU 102, or any combination thereof. Such specified memory locations include data (e.g., memory addresses) indicating one or more locations within one or more memories 106, for example, a pseudo-channel, channel, bank, sub-bank of the channel, or any combination thereof, in which to place data indicated by one or more instructions from program code 110, APU 114, CPU 102, or any combination thereof. In embodiments, the memory locations for one or more instructions are indicated by one or more data layouts within program code 110 that each indicate the layout of data (e.g., where data is located) within a data structure (e.g., array). That is to say, data is laid out within a data structure in program code 110 in such a way as to indicate one or more memory locations within one or more memories 106.

To determine these data layouts, processing system 100 (e.g., executing program code 110) uses one or more memory mappings (e.g., data indicating memory addresses within a memory 106), the architecture of the memory 106, or both. The architecture of a memory 106 indicates, for example, the number of layers, number of channels, number of channels per layer, number of memory banks, number of memory banks per channel, number of pseudo channels, number of pseudo channels per channel, number of memory sub-banks per memory bank, or any combination thereof in a memory 106. Using the memory architecture, memory mappings, or both, processing system 100 determines a data layout corresponding to desired memory locations within a memory 106. That is to say, a data layout that includes data arranged in a data structure (e.g., array) in program code 110 that, when executed (e.g., by APU 114, CPU 102, PIM unit 118), causes the data indicated in the data structure to be stored in one or more desired memory locations within a memory 106. For example, processing system 100 determines one or more positions within an array in program code 110 to indicate data to be stored and one or more positions within an array to leave empty (e.g., unused elements) such that when program code 110 is executed, the data to be stored is stored within one or more desired memory locations within a memory 106 (e.g., one or more desired channels within a memory 106). However, in some embodiments, determining data layouts for corresponding memory locations in this way lessens the security of processing system 100 by exposing the memory architecture, memory mappings, or both of a memory 106 to the program code 110, malicious software, or both. Additionally, determining data layouts for corresponding memory locations in this way lowers the processing efficiency of processing system 100 by including data structures (e.g., arrays) that are larger than needed, such as those that include empty positions (e.g., unused elements) in order to correspond to a desired memory layout.

In embodiments, to help increase the processing efficiency of processing system 100 while maintaining a secure environment, APU 114, CPU 102, or both include a PIM circuitry (not illustrated for clarity purposes). The PIM circuitry includes, for example, hardware-based circuitry included in or otherwise connected to APU 114, CPU 102, or both and configured to determine memory addresses in which to store data for one or more instructions based on one or more memory mapping requests from program code 110. Such memory mapping requests, for example, include data indicating a location (e.g., layer, channel, pseudo-channel, memory bank, memory sub-bank) within a memory 106 in which to store data (e.g., results) for one or more instructions from program code 110, one or more instructions from program code 110, the size of data to be stored, a host device (e.g., APU 114, CPU 102), or any combination thereof. In response to receiving a memory mapping request, the PIM circuitry is first configured to allocate at least a portion of memory 106 to the host device large enough to store the data indicated in the memory mapping request in the location indicated by the memory mapping request (e.g., based on the indicated size of the data to be stored). To this end, for example, the PIM circuitry generates a memory allocation request based on the received memory mapping request that includes data requesting the allocation of a location within memory 106 to a host device large enough to store the data indicated in the memory mapping request. The PIM circuitry then sends the memory allocation request, for example, to operating system 108, a driver, a hypervisor, or any combination thereof, configured to allocate one or more locations within memory 106 based on the memory allocation request. As an example, operating system 108, a driver, a hypervisor, or any combination thereof allocates enough space within a memory 106 to a host device so as to place the size of data indicated in the memory mapping request in any location (e.g., channel) of a memory 106 indicated in the memory mapping request.

After the portions of the memory 106 have been allocated to the host device, the PIM circuitry then determines one or more memory addresses in which to store data within the location of the memory 106 indicated by the memory mapping request. For example, the PIM circuitry uses the memory mapping, memory architecture, or both of a memory 106 to determine memory addresses within the location (e.g., channel) of the memory 106 in which to store data. Once the memory addresses within the location of the memory 106 are determined, the PIM circuitry issues instructions to one or more PIM units 118 of a memory 106 such that the PIM units 118 store the data at the determined memory addresses within the location of memory 106 indicated in the memory mapping request (e.g., in a channel indicated by the memory mapping request). As such, the PIM circuitry allows data from the instructions of program code 110 to be stored in desired memory locations within a memory 106 without exposing the memory architecture, memory addresses, or both of memory 106 to program code 110 or other software, helping improve the security of processing system 100.

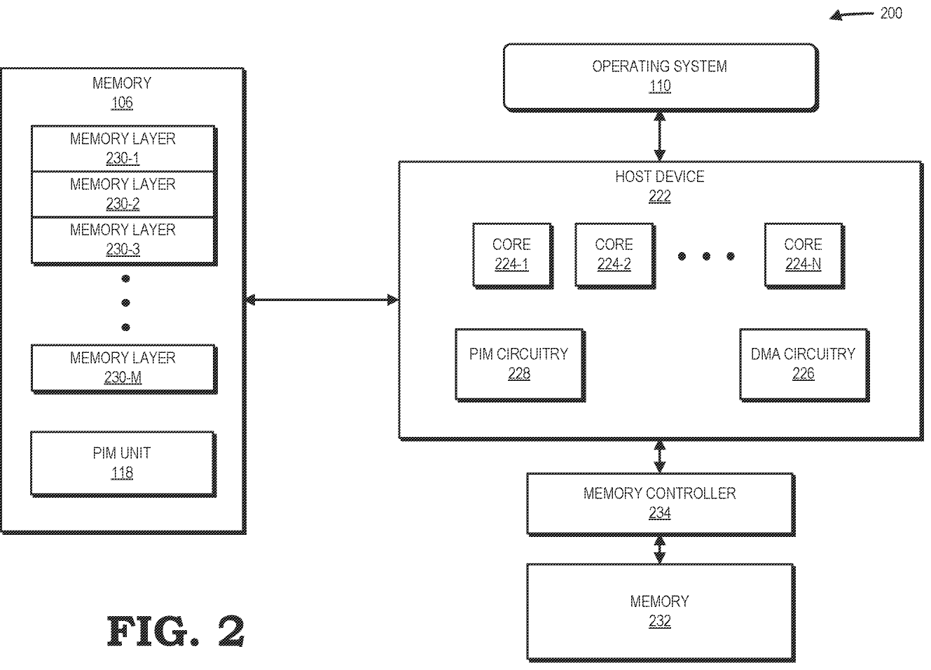

Referring now to FIG. 2, a processing system 200 including a host device implementing hardware-assisted memory data placement is presented. In embodiments, processing system includes host device 222, similar to or the same as CPU 102, APU 114, connected to a memory 106. According to embodiments, memory 106 includes a stack memory (e.g., SDRAM) having one or more memory layers 230 that each have one or more memory channels, memory pseudo channels, memory banks, memory subbanks, or any combination thereof, and a PIM unit 118. Though the illustrated embodiment of FIG. 2 presents memory 106 as having four memory layers (230-1, 230-2, 230-3, 230-M) representing an M number of layers, in other embodiments, memory 106 may have any number of memory layers 230. According to embodiments, host device 222 is further connected to a second memory 232, similar to or the same as memory 106. For example, in embodiments, the second memory 232 includes a stacked memory (e.g., SDRAM) having one or more memory layers and a PIM unit 118. In embodiments, host device 222 is connected to memory 106, memory 232, or both by a respective memory controller 234. A memory controller 234 includes, for example, hardware-based circuitry, software-based circuitry, or both configured to access, modify, and delete data in memory 106, memory 232, or both. For example, a memory controller 234 is configured to access, modify, and delete data in memory banks and memory sub-banks of one or more memory layers 230 of memory 106.

In embodiments, host device 222 is configured to execute one or more instructions received from program code 110. To this end, host device 222 includes one or more processor cores 224, similar to or the same as processor cores 104, 116. For example, each processor core 224 operates as a compute unit including one or more SIMD units that perform the same operation on different data sets indicated by instructions received from program code 110. Though the example embodiment illustrated in FIG. 2 presents host device 222 having three processor cores (224-1, 224-2, 224-N) representing an N number of processor cores, in other embodiments, host device 222 can include any number of processor cores. Such instructions, when executed by a processor core 224, cause the processor core 224 to perform one or more operations indicated by the instructions, read data from one or more locations in a memory, store data (e.g., results) in one or more locations in a memory, or any combination thereof. As an example, one or more instructions cause a processor core 224 to perform an operation and store the data resulting from the performance of the operation at a location within memory 106. According to embodiment embodiments, in response to receiving one or more instructions from program code 110, one or more processor cores 224 are configured to issue one or more requests (e.g., direct memory access (DMA) requests) to DMA circuitry 226. DMA circuitry 226 includes hardware-based circuitry, software-based circuitry, or both configured to facilitate the exchange of data between memory 106, memory 232, or both and one or more peripheral input/output (I/O) devices (not pictured for clarity). Such DMA requests, for example, include data to be read from a first location (e.g., a memory, an I/O device) and stored (e.g., written, copied) in a second location (e.g., another memory, another I/O device). For example, in response to receiving a DMA request from a processor core 224, DMA circuitry issues one or more instructions, commands, or both to memory 106 and an I/O device such that data is copied from memory 106 to the I/O device.

Additionally, in response to receiving one or more instructions from program code 110, one or more processor cores 224 are configured to issue one or more instructions to one or more PIM units 118 in a respective memory. For example, based on a received instruction indicating memory 106, one or more processor cores 224 are configured to issue one or more instructions to one or more PIM units 118 in memory 106. Such instructions, when executed by a PIM unit 118, cause the PIM unit 118 to perform one or more operations indicated by the instructions, read data from one or more locations in a memory, store data (e.g., results) in one or more locations in a memory, or any combination thereof. In embodiments, one or more instructions issued from a processor core 224 to a PIM unit 118 include data indicating one or more locations (e.g., memory layer 230, channel, pseudo channel, memory bank, memory sub-bank) within a respective memory (e.g., memory 106) in which to store data (e.g., data resulting from the performance of one or more operations).

To determine memory addresses for such locations, host device 222 includes or is otherwise coupled to PIM circuitry 228. PIM circuitry 228 includes, for example, hardware-based circuitry configured to determine memory addresses in which to store data for one or more instructions issued by a processor core 224 to a PIM unit 118. In some embodiments, PIM circuitry 228 is included in DMA circuitry 226 while in other embodiments PIM circuitry 228 is distinct from DMA circuitry 226. In response to receiving one or more instructions from program code 110, a processor core 224 is configured to provide one or more instructions to PIM circuitry 228 indicating one or more memory commands and one or more memory mapping requests. Such memory commands, for example, include data indicating one or more operations to be performed by a PIM unit 118, data to be stored by a PIM unit 118, data to be ready by a PIM unit 118, an amount (e.g., size) of data to be stored in a respective memory (e.g., memory 106, memory 232), or any combination thereof. Such memory mapping requests, for example, include data indicating one or more desired locations within a respective memory to store data (e.g., a memory layer 230, channel, pseudo channel, memory bank, memory sub-bank). After receiving the instructions from a processor core 224, PIM circuitry 228 is configured to allocate a portion of a respective memory (e.g., a memory indicated in the received instructions) to host device 222 based on the received instructions. For example, PIM circuitry 228 is configured to allocate a portion of a respective memory (e.g., memory 106) to host device 222 large enough to store the amount of data indicated in the received memory command and memory mapping request. To this end, PIM circuitry 228 is configured to generate one or more memory allocation requests based on a received instruction with each memory allocation request including data requesting the allocation of a location (e.g., as indicated in a received memory mapping request) within a respective memory (e.g., memory 106, 232) to host device 222 large enough to store the data indicated in the received memory command. PIM 228 circuitry then sends the memory allocation request to operating system 108 which is configured to allocate one or more locations within the respective memory (e.g., memory 106, 232) based on the memory allocation request. As an example, operating system 108 allocates enough space within memory 106 to host device 222 so as to place the size of data indicated in the memory allocation request in any pseudo channel of memory 106.

After the portions of the respective memory (e.g., memory 106, 232) have been allocated to the host device 222, PIM circuitry 228 then generates one or more instructions indicating one or more memory placement commands and provides the instructions to one or more PIM units 118 of the respective memory. Such memory placement commands, for example, indicate one or more operations to be performed by a PIM unit 118, data to be stored by a PIM unit 118, data to be read by a PIM unit 118, one or more memory addresses within the respective memory in which to store data, or any combination thereof. To determine such memory addresses, PIM circuitry 228 uses a memory mapping associated with a respective memory, the memory architecture associated with a respective memory, the received memory mapping requests identifying a location within the respective memory (e.g., a channel of the memory), or any combination thereof. As an example, based on the memory architecture (e.g., number of channels of memory 106), a memory mapping, and a memory mapping request identifying a first channel of memory 106, PIM circuitry 228 determines one or more memory addresses within the first channel of memory 106 and generates one or more memory placement commands (e.g., instructions indicating such memory placement commands) that indicate an operation to be performed by a PIM unit 118, data to be stored at the determined memory addresses within the first channel of memory 106, data to be read from memory 106, or any combination thereof. In this way, PIM circuitry 228 allows data resulting from the instructions of program code 110 to be stored in desired memory locations within a respective memory (e.g., memory 106, memory 232) without exposing the memory architecture, memory mapping, or both of the memory to program code 110 or other software, helping improve the security of processing system 200.

In some embodiments, one or more memory placement commands generated by PIM circuitry 228 include one or more hashed memory addresses. That is to say, PIM circuitry 228 is configured to hash (e.g., perform memory bank hashing, memory bank group hashing, pseudo channel hashing, channel hashing) on one or more memory addresses from a respective memory. For example, PIM circuitry 228 is configured to perform hashing one or more memory addresses in response to a type of hashing (e.g., memory bank hashing, memory bank group hashing, pseudo channel hashing, channel hashing) being indicated as enabled in a memory mapping related to a memory 106. As an example, based on the memory architecture (e.g., number of pseudo channels of memory 106) of a memory, the memory mapping of the memory, an indication that channel hashing is enabled for the memory (e.g., as indicated in the memory mapping), and the memory mapping request identifying a first channel of the memory, PIM circuitry 228 generates one or more memory placement commands (e.g., instructions indicating such memory placement commands) that indicate an operation to be performed by a PIM unit 118, data to be stored at respective hashed memory addresses (e.g., using channel hashing) within the first channel of the memory, data to be read from the memory, or any combination thereof.

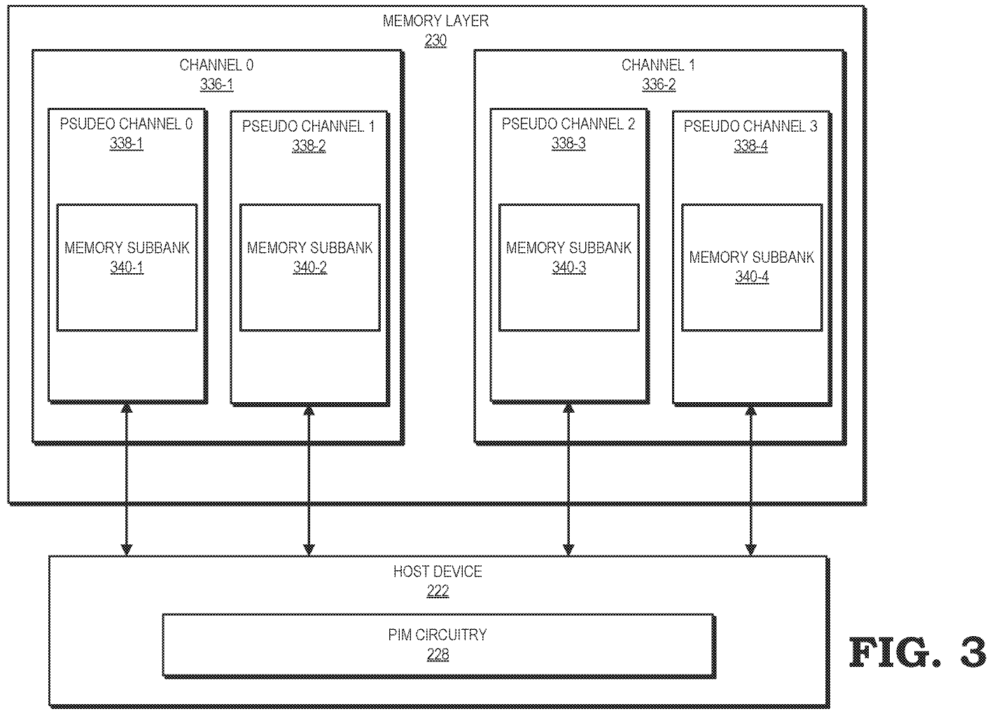

Referring now to FIG. 3, a memory layer connected to a host device implementing hardware-assisted memory data placement is presented. In embodiments, host device 222 is communicatively coupled to memory layer 230 of a memory (e.g., memory 106, 232). According to embodiments, memory layer 230 includes one or more channels 336 each configured to allow access to the data in one or more memory banks, memory subbanks, or both of memory layer 230. In some embodiments, each channel 336 is configured to allow access to the data in one or more distinct memory banks of memory layer 230. For example, in the example embodiment illustrated in FIG. 3, memory layer 230 includes channel 0 336-1 configured to allow access to a first memory bank (not illustrated for clarity) and channel 1 336-2 configured to allow access to a second memory bank (not illustrated for clarity). Each channel 336 has a width representing the maximum amount of data allowed to be concurrently read from or written to the memory banks associated with the channel 336. For example, each channel 336 has a width of 64 bits.

In embodiments, memory layer 230 is configured to operate in a pseudo channel mode. While in the pseudo channel mode, each channel 336 of memory layer 230 operates as two or more distinct pseudo channels 338. For example, in the example embodiment illustrated in FIG. 3, while in a pseudo channel mode, channel 0 336-1 operates as pseudo channel 0 338-1 and pseudo channel 1 338-2 and channel 1 336-2 operates as pseudo channel 2 338-3 and pseudo channel 3 338-4. Each pseudo channel 338 is configured to allow access to the data in at least a portion of the memory banks, memory subbanks, or both associated with its respective channel 336. For example, in the example embodiment illustrated in FIG. 3, pseudo channel 0 338-1 is configured to allow access to a first memory subbank 340-1 which is a memory subbank of the memory bank associated with channel 0 336-1 and pseudo channel 1 338-2 is configured to allow access to a second memory subbank 340-2 which a second, different memory subbank of the memory bank associated with channel 0 336-1. As another example, in the example embodiment illustrated in FIG. 3, pseudo channel 2 338-3 is configured to allow access to a third memory subbank 340-3 which is a memory subbank of the memory bank associated with channel 1 336-2 and pseudo channel 3 338-4 is configured to allow access to a fourth memory subbank 340-4 which a second, different memory subbank of the memory bank associated with channel 1 336-2 Each pseudo channel 338 has a width representing the maximum amount of data allowed to be concurrently read from or written to the memory banks, memory subbanks, or both associated with the pseudo channel 338. According to embodiments, each pseudo channel has a width equal to half the width of its associated channel. For example, in the example embodiment illustrated in FIG. 3, channel 0 336-1 has a width of 64 bits making the widths of pseudo channel 0 338-1 and pseudo channel 1 338-2 32 bits.

In embodiments, memory layer 230 is connected or otherwise communicatively coupled to a PIM unit 118 (not pictured for clarity). For example, memory layer 230 is connected to a logic layer that includes one or more PIM units 118. Each PIM unit 118 is configured to perform one or more operations, store data in memory layer 230, read data from memory layer 230, or any combination thereof based on one or more instructions received from PIM circuitry 228. For example, PIM circuitry 228 is configured to issue one or more instructions indicating one or more memory placement commands to a PIM unit 118 connected to memory layer 230. Such memory placement commands, for example, indicate one or more operations to be performed by a PIM unit 118, data to be stored by a PIM unit 118 in memory layer 230, data to be read by a PIM unit 118 from memory layer 230, one or more memory addresses within memory layer 230, or any combination thereof. For example, a memory placement command indicates data to be stored at certain memory addresses within a channel 336 of memory layer 230. In response to receiving one or more instructions indicating one or more memory placement commands, the PIM unit 118 is configured to perform operations, read data, store data, or any combination thereof within memory layer 230 based on the received instructions. For example, in response to receiving one or more instructions from PIM circuitry 228, the PIM unit 118 is configured to store data at memory addresses within channel 0 336-1 indicated in the memory placement commands of the instructions. As such, the PIM circuitry 228 is configured to issue instructions to the PIM unit 118 without exposing the architecture of memory layer 230 or the memory mapping of memory layer 230 to program code 110 or other software, helping increase the security of the processing system.

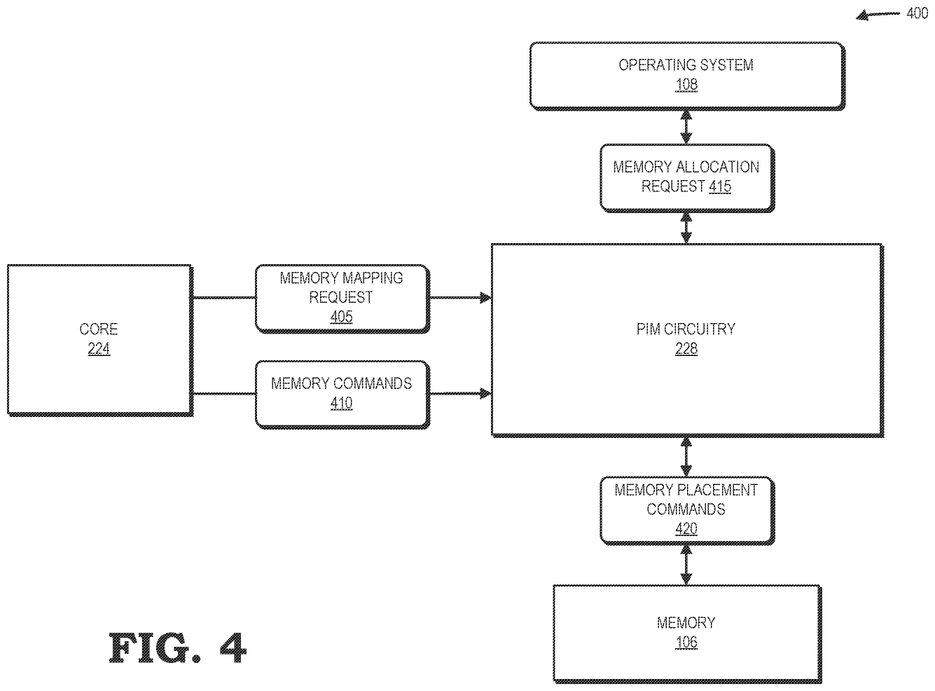

Referring now to FIG. 4, an example process 400 for hardware-assisted memory data placement is presented. In embodiments, example process 400 first includes receiving one or more instructions from program code 110. Such instructions, for example, indicate one or more operations to be completed, data to be written, the size of data to be written, data to be read, a memory (e.g., memory 106, 232), one or more locations of a memory (e.g., layer, channel, pseudo channel, memory bank, memory subbank) for data to be written, or any combination thereof. For example, such instructions indicate one or more operations to be performed, data (e.g., results of the operations) to be written, and a location (e.g., channel) in memory 106 in which to write the data. In response to receiving these instructions, core 224 is configured to determine one or more instructions each indicating a memory mapping request 405 and one or more memory commands 410 based on the received instructions. Such memory commands 410, for example, include data indicating one or more operations to be performed by a PIM unit 118, data (e.g., results) to be saved in a memory by a PIM unit 118, the size (e.g., amount) of data to be written, data to be read from a memory by a PIM unit 118, or any combination thereof. The memory mapping request 405, for example, includes data indicating a location within a memory (e.g., layer, channel, pseudo channel, memory bank, memory subbank) in which to write data for one or more instructions. For example, based on or more received instructions indicating one or more operations to be performed, data to be written, and a location (e.g., channel) within memory 106, core 224 is configured to determine one or more memory commands 410 indicating the operations and the amount of data to be saved and a memory mapping request 405 indicating the location (e.g., channel) within memory 106. Core 224 then sends one or more instructions indicating one or more memory mapping requests 405 and one or more memory commands 410 to PIM circuitry 228.

In embodiments, in response to receiving one or more instructions indicating a memory mapping request 405 and a memory command 410, PIM circuitry 228 is configured to generate a memory allocation request 415. The memory allocation request 415 includes data requesting an allocation of at least a portion of a memory (e.g., memory 106, memory 232) to host device 222 based on the memory mapping request 405 and memory command 410 indicated in the received instructions. For example, based on a memory command 410 indicating a size of data to be written and a memory mapping request 405 indicating a channel of a memory 106, PIM circuitry 228 generates a memory allocation request 415 requesting an allocation of at least a portion of memory 106 based on the size of data to be written and the indication of a channel. As an example, the memory allocation requests 415 requests an allocation of at least a portion of memory 106 to host device 222 large enough so that the amount of data indicated in memory command 410 can be written to any channel of memory 106. After generating the memory allocation request 415, PIM circuitry 228 sends the memory allocation request 415 to operating system 108 which, in turn, allocates at least a portion of a respective memory based on the memory allocation request 415. For example, operating system 108 allocates a portion of memory 106 large enough so that the amount of data indicated in memory command 410 can be written to any channel of memory 106.

According to embodiments, example operation 400 includes PIM circuitry 228 generating one or more memory placement commands 420. For example, in response to operating system 108 allocation at least a portion of a memory to host device 222, PIM circuitry 228 is configured to generate one or more instructions indicating one or more memory placement commands 420. These memory placement commands 420, for example, include data indicating one or more operations to be performed by a PIM unit 118, data to be read by a PIM unit 118, data to be written by a PIM unit 118, memory addresses within memory 106 in which to write data, or any combination thereof. In embodiments, to determine such memory placement commands 420, PIM circuitry 228 is configured to determine one or more memory addresses within memory 106 based on a memory mapping of memory 106, an architecture of memory 106, a memory mapping request 405, or any combination thereof. For example, based on a memory mapping request 405 indicating a channel (e.g., channel 0) of memory 106, PIM circuitry 228 is configured to use a memory mapping of memory 106 and the architecture of memory 106 to determine memory addresses within the channel (e.g., channel 0) in which to write data (e.g., results) from one or more operations to be performed by a PIM unit 118. After determining the memory addresses within memory 106, PIM circuitry 228 is configured to send one or more instructions indicating the memory placement commands 420 to one or more PIM units 118 of memory 106.

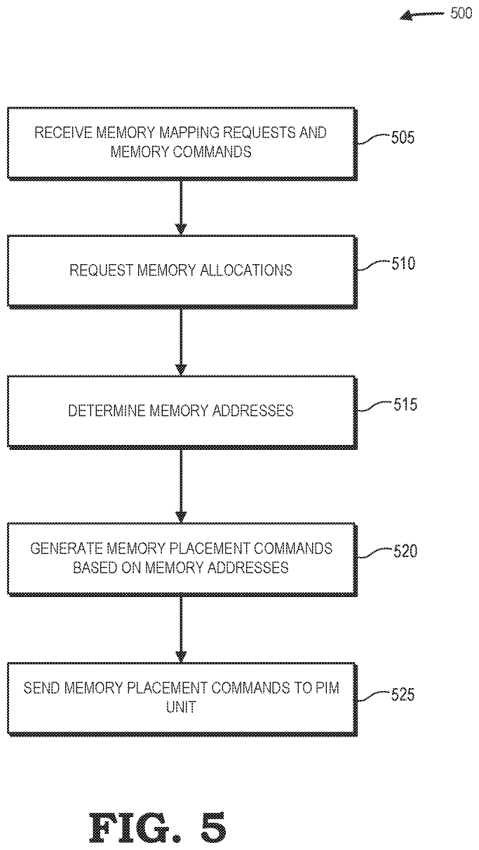

Referring now to FIG. 5, an example method 500 for hardware-assisted memory data placement is presented. At step 505 of example method 500, a PIM circuitry, similar to or the same as PIM circuitry 228, receives one or more instructions indicating one or more memory mapping requests (e.g., memory mapping request 405) and one or more memory commands (e.g., memory commands 410) from a processor core (e.g., processor cores 104, 116, 224, of a host device (e.g., host device 222). Such memory commands, for example, indicate one or more operations to be performed by a PIM unit, similar to or the same as PIM unit 118, data to be written to a memory 106, the amount of data to be written to the memory 106, or any combination thereof. Such memory mapping requests, for example, indicate a location (e.g., layer, channel, pseudo channel, memory bank, memory subbank) in memory 106 in which data is to be written. At step 510, the PIM circuitry generates one or more memory allocation requests (e.g., memory allocation request 415) each requesting an allocation of at least a portion of a memory to a host device (e.g., host device 222) based on the received memory commands and memory mapping requests. For example, the PIM circuitry generates a memory allocation request requesting that a least a portion of a memory large enough to fit the size of the data indicated in a received memory command in each location (e.g., channel) indicated in a received memory mapping request. After generating the memory allocation request, the PIM circuitry sends the memory allocation request to the operating system (e.g., operating system 108) which is configured to allocate at least a portion of a memory based on the received memory allocation request.

At step 515, the PIM circuitry is configured to determine one or more memory addresses based on the received memory mapping requests and memory commands. For example, the PIM circuitry is configured to determine memory addresses within a location (e.g., channel) indicated in a memory mapping request in which to store the data indicated in a memory command. To help determine such memory addresses, the PIM circuitry uses a memory mapping of the memory, the architecture of the memory, or both. As an example, using a memory mapping of a memory, the PIM circuitry is configured to determine memory addresses within a location (e.g., channel) indicated in a memory mapping request in which to store the data indicated in a memory command. At step 520, the PIM circuitry is configured to generate one or more memory placement commands based on the determined memory addresses. Such memory placement commands include data indicating one or more operations to be performed by a PIM unit, memory addresses with a location of a memory in which to store data, data to store, or any combination thereof. As an example, based on a received memory command indicating an operation to be performed and to store data resulting from the operation and the determined memory addresses, the PIM circuitry generates a memory placement command indicating the operation and that data resulting from the operation is to be stored in at least one memory address of the determined memory addresses (e.g., generate an instruction to store data at a memory address of the determined memory addresses). At step 525, the PIM circuitry sends instructions (e.g., one or more instructions to store data) indicating the memory placement commands to one or more PIM units of a memory which, in turn, perform operations and store data according to the received memory placement commands.

In some embodiments, the apparatus and techniques described above are implemented in a system including one or more integrated circuit (IC) devices (also referred to as integrated circuit packages or microchips), such as the processing system implementing hardware-assisted memory data placement described above with reference to FIGS. 1-5. Electronic design automation (EDA) and computer-aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer-readable storage medium accessible to the computing system. Likewise, the code representative of one or more phases of the design or fabrication of an IC device may be stored in and accessed from the same computer-readable storage medium or a different computer-readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc , magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
in response to receiving an instruction to store data at a location in a memory, determining, at a processor in memory (PIM) circuitry at a processor, a memory address within the location in the memory; and
issuing instructions to store data in the memory address within the location in the memory to a PIM unit of the memory.

2. The method of claim 1, further comprising:
generating, at the PIM circuitry, a memory allocation request based on the location in the memory indicated by the instruction; and
sending the memory allocation request to an operating system.

3. The method of claim 1, wherein the PIM circuitry is configured to determine the memory address within the location in the memory based on a memory mapping associated with the memory.

4. The method of claim 3, wherein the PIM circuitry is configured to hash the memory address based on the memory mapping associated with the memory.

5. The method of claim 1, wherein the location in the memory indicates a channel of the memory.

6. The method of claim 1, wherein the PIM circuitry is included in a direct memory access (DMA) circuitry of the processor.

7. The method of claim 1, wherein the memory comprises a stacked memory.

8. A processing system, comprising:
a memory including a processing in memory (PIM) unit; and
a processor coupled to the memory, the processor comprising:
a plurality of processor cores; and
a PIM circuitry configured to:
in response to receiving an instruction from a processor core of the plurality of processor cores to store data at a location in the memory, determine a memory address within the location in the memory; and
issue instructions to store data in the memory address within the location in the memory to the PIM unit of the memory.

9. The processing system of claim 8, the PIM circuitry is configured to:
generate a memory allocation request based on the location in the memory indicated by the instruction; and
send the memory allocation request to an operating system associated with the processor.

10. The processing system of claim 8, wherein the PIM circuitry is configured to determine the memory address within the location in the memory based on a memory mapping associated with the memory.

11. The processing system of claim 10, wherein the PIM circuitry is configured to hash the memory address based on the memory mapping associated with the memory.

12. The processing system of claim 8, wherein the location in the memory indicates a channel of the memory.

13. The processing system of claim 8, wherein the processor further includes a direct memory access (DMA) circuitry and wherein the PIM circuitry is included in the DMA circuitry.

14. The processing system of claim 8, wherein the memory comprises a stacked memory.

15. A processor, comprising:
a plurality of processor cores; and
a processing in memory (PIM) circuitry configured to:
in response to receiving an instruction from a processor core of the plurality of processor cores to store data at a location in a memory, determine a memory address within the location in the memory; and
issue instructions to store data in the memory address within the location in the memory to a PIM unit of the memory.

16. The processor of claim 15, wherein the PIM circuitry is configured to:
generate a memory allocation request based on the location in the memory indicated by the instruction; and
send the memory allocation request to an operating system associated with the processor.

17. The processor of claim 15, wherein the PIM circuitry is configured to determine the memory address within the location in the memory based on a memory mapping associated with the memory.

18. The processor of claim 17, wherein the PIM circuitry is configured to hash the memory address based on the memory mapping associated with the memory.

19. The processor of claim 15, wherein the location in the memory indicates a channel of the memory.

20. The processor of claim 15, wherein the memory comprises a stacked memory.
